(19) United States
(12) Patent Application Publication
(10) Pub. No.: US 2026/0041047 A1
(43) Pub. Date: Feb. 12, 2026

(54) SYSTEM AND DEVICES FOR RAPID PAD REPLACEMENT OF BURR COLLECTION SYSTEMS AND METHODS

(71) Applicant: Sticker Picker, LLC, Stephenville, TX (US)

(72) Inventor: Marilyn S. Vice, Stephenville, TX (US)

(73) Assignee: Sticker Picker, LLC, Stephenville, TX (US)

(21) Appl. No.: 19/364,887

(22) Filed: Oct. 21, 2025

Related U.S. Application Data
(63) Continuation-in-part of application No. 18/532,099, filed on Dec. 7, 2023.

(51) Int. Cl. A01G 20/43; B08B 1/16; B08B 1/34

(52) U.S. Cl. CPC A01G 20/43; B08B 1/165; B08B 1/34

(57) ABSTRACT

A system and apparatus, and method for collecting spiked objects from a surface. In embodiments, a spiked object collection system includes a frame configured to receive a propulsion force to move the system along the surface, and a roller assembly rotatably mounted to the frame. The roller assembly includes a cylindrical drum configured to rotate about an axle, and a roller pad wound about the cylindrical drum. The roller pad includes a plurality of pad segments separated by segment dividers configured to facilitate removal of a used pad segment and exposure of a clean pad segment without disassembly of the system. In embodiments, the frame includes a hinge configured to allow folding of the frame between an extended position for operation and a folded position for storage or shipment. In embodiments, the cylindrical drum is formed by injection molding or blow molding for improved manufacturability, balance, and lightweight construction.

### CROSS-REFERENCE TO RELATED APPLICATIONS

The present application is a Continuation-in-Part of U.S. patent application Ser. No. 18/532,099, filed on Dec. 7, 2023, the entirety of which is herein incorporated by reference for all purposes.

### TECHNICAL FIELD

The present disclosure relates generally to environmental maintenance tools, and more particularly to devices configured for collection and/or removal of spiked objects from various surfaces.

### BACKGROUND

Stickers, also known as grass stickers, prickly thorns, goat heads, sticker burrs, sandburs, and similar spiked objects, are a widespread problem in many environments, ranging from agricultural fields to suburban lawns. These stickers, often originating from plants such as burdock, cocklebur, and various species of thistles, are not only a nuisance but also pose several problems. For example, stickers can adhere to clothing, the fur of animals, and even human skin, causing discomfort and potential injury. In agricultural settings, these stickers can contaminate crops, interfere with harvesting processes, and harm livestock. In residential areas, stickers can render lawns and gardens unusable for recreational activities.

As significant a problem as stickers may be, the primary method of dealing with stickers has traditionally been manual removal. This labor-intensive process involves individuals picking up these stickers by hand, which is not only time-consuming but also inefficient for large-scale removal. Furthermore, manual removal may pose a risk of injury to those performing the manual removal, as the stickers can be sharp and difficult to handle.

Some devices have been proposed for the removal of stickers. For example, one particular device uses a roller that is rotatably moved over the ground surface where the stickers may be. As the surface of the roller makes contact with the stickers, the stickers adhere to the surface of the roller and are, in this manner, picked up from the ground. However, these devices do present some shortcomings.

For example, these existing devices may lack an efficient mechanism for clean-up and disposal of the stickers once the stickers have been collected. Users of these devices may frequently face the challenge of manually clearing the devices of the collected burrs, which may reintroduce inefficiencies and potential injuries that the devices were intended to eliminate. Some solutions employ a roller that includes a sleeve or covering to which the stickers adhere during operation. However, replacing the sleeve after it becomes full of stickers can be cumbersome and time-consuming because the sleeve must be slid off the roller, cleaned, and then reinstalled. In many cases, removal of the sleeve may require disassembly of the roller assembly or other components of the device, further increasing the complexity and downtime associated with maintenance.

Additionally, previously known devices may include rigid frame constructions that occupy substantial space during storage or shipment, which may complicate handling and reducing portability. Many existing roller assemblies may also require machined or multi-component metallic drums that add weight, increase cost, and complicate manufacturing and balance of the roller.

### SUMMARY

The present disclosure achieves technical advantages as a device for collecting spiked objects, and/or methods of manufacturing and/or using a device for collecting spiked objects, that includes functionality for rapid pad replacement functionality, a foldable storage configuration, and improved manufacturability of the cylindrical drum component. In embodiments, the spiked object collection system of the present disclosure may include a roller pad configured as a segmented, replaceable collection surface comprising a plurality of pad segments separated by segment dividers. In embodiments, each pad segment may be configured to be selectively removed and replaced without disassembly of the system, enabling continuous operation and easy renewal of the collection surface. In embodiments, the frame of the spiked object collection system of embodiments may be configured to include a hinge disposed between a first frame section and a second frame section, the hinge configured to allow folding of the frame between an extended position suitable for operation and a folded position suitable for storage and/or shipment. In embodiments, the cylindrical drum of the roller assembly may be configured to be formed by injection molding or blow molding, enabling precise geometry, lightweight construction, and material uniformity during manufacturing.

Accordingly, embodiments of the present disclosure may provide enhanced functionality over existing devices. In embodiments, the segmented configuration of the roller pad may facilitate rapid removal of used pad segments and exposure of new, clean pad segments, minimizing downtime and eliminating the need for manual cleaning of collected spiked objects. In embodiments, the foldable configuration of the frame may allow the spiked object collection system to occupy a reduced footprint during storage or shipment, facilitating portability and lowering manufacturing and distribution costs. In embodiments, the injection-molded or blow-molded cylindrical drum may enable improved manufacturability, structural stability, and balance of the roller assembly during operation. In this manner, the spiked object collection systems and methods of manufacturing and using such systems as disclosed herein may provide improved efficiency, maintainability, and usability in collecting spiked objects from a wide range of surfaces.

It is an object of the disclosure to provide a device for collecting spiked objects from surfaces. It is a further object of the disclosure to provide a method of manufacturing a device for collecting spiked objects from surfaces. It is still a further object of the disclosure to provide a method of using a device for collecting spiked objects from surfaces.

In one particular embodiment, a spiked object collection system for collecting spiked objects from surfaces is provided. The system includes a frame configured to support a roller assembly and a hinge disposed between a first frame section and a second frame section. In embodiments, the hinge is configured to facilitate folding of the frame between an extended position for operation and a folded position for storage. The system further includes a cylindrical drum rotatably mounted to the frame and configured to rotate about an axle, and a roller pad wound about the cylindrical drum. In embodiments, the roller pad includes a plurality of pad segments separated by segment dividers configured to enable removal of a used pad segment and exposure of a clean pad segment without disassembly of the spiked object collection system.

In another embodiment, a method of manufacturing a spiked object collection system configured for collection of spiked objects from a surface is provided. The method includes forming a cylindrical drum by molding a polymeric material into a hollow drum body configured to rotate about an axle and coupling the cylindrical drum to a frame. In embodiments, the frame includes a first frame section and a second frame section joined by a hinge configured to allow folding of the frame between an extended position for operation and a folded position for shipping. The method also includes rolling a roller pad about the cylindrical drum. In embodiments, the roller pad includes a plurality of pad segments separated by segment dividers configured to facilitate removal of a used pad segment and exposure of a clean pad segment during operation of the spiked object collection system.

In yet another embodiment, a method of collecting spiked objects from surfaces using a spiked object collection device is provided. The method includes advancing a roller assembly of a spiked object collection system along a surface such that an outer surface of a roller pad of the roller assembly contacts the surface and collects spiked objects disposed thereon, rotating the roller assembly about an axle as the roller assembly advances along the surface, removing a used pad segment of the roller pad along a segment divider configured to separate the used pad segment from a remaining portion of the roller pad, and exposing a clean pad segment of the roller pad for continued collection of spiked objects without disassembly of the spiked object collection system.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 shows an exemplary spiked object collection system configured with capabilities and functionality for collecting spiked objects from ground surfaces and for rapid roller pad replacement in accordance with embodiments of the present disclosure.

FIGS. 2A and 2B show exemplary embodiments of the roller pad of the spiked object collection system 100 configured with a segmented configuration in accordance with embodiments of the present disclosure.

FIG. 3A shows an exemplary spiked object collection system during operation for collecting spiked objects from ground surfaces in accordance with embodiments of the present disclosure.

FIGS. 3B and 3C illustrate operations of a spiked object collection system configured with foldable configurations in accordance with embodiments of the present disclosure.

FIGS. 4A-4C illustrate operations for refreshing roller pad by removal of a saturated pad segment in accordance with embodiments of the present disclosure.

FIGS. 5A-5C exemplary operations of a spiked object collection device propelled bunder various propulsion configurations in accordance with embodiments of the present disclosure.

FIG. 6 shows a high-level flow diagram of operation for collecting spiked objects from a surface in accordance with embodiments of the present disclosure.

FIG. 7 shows an exemplary flow diagram of operations for manufacturing a device configured with functionality to collect spiked objects from a surface in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

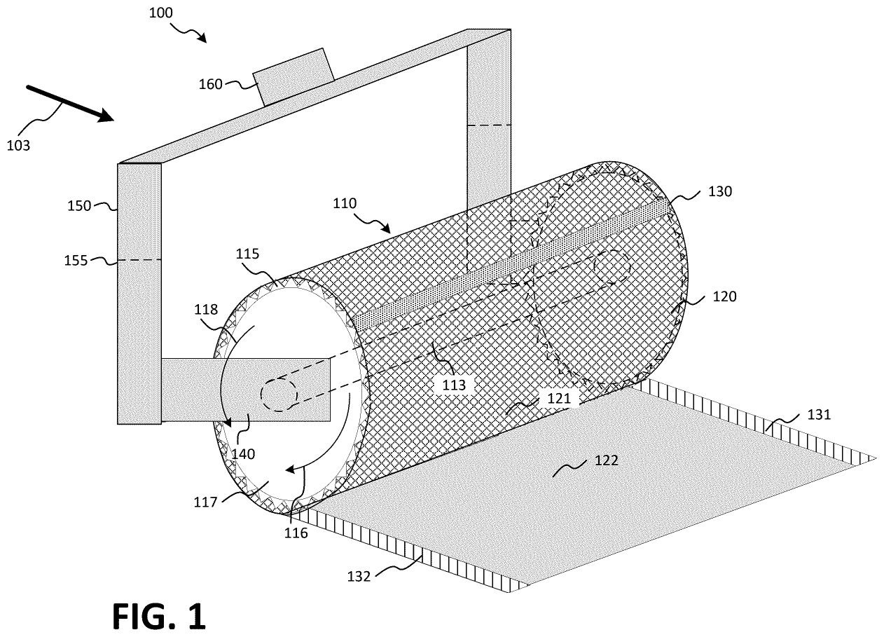

FIG. 1 shows an exemplary spiked object collection system 100 configured with capabilities and functionality for collecting spiked objects from ground surfaces and for rapid roller pad replacement in accordance with embodiments of the present disclosure. In embodiments, the spiked object collection system 100 may be configured for collecting spiked objects such as stickers, burrs, goat heads, thorns, and/or similar debris from a surface such as a ground surface. In embodiments, the spiked object collection system 100 provides a portable, rollable assembly that may be manually propelled or vehicle propelled to collect spiked objects from a variety of terrains.

As shown in FIG. 1, spiked object collection system 100 includes frame 150, roller assembly 110, and roller pad 120, and these components may be configured to include various components and/or configurations for providing functionality as described in various embodiments of the present disclosure. It is noted that the spiked object collection system 100 shown in FIG. 1 is illustrated with the roller pad 120 partially unrolled to expose a portion of an outer surface 121 and an inner surface 122 for clarity of illustration.

In embodiments, movement of the spiked object collection system 100 occurs generally along a direction 103, while rotation of the roller assembly 110 occurs in a direction 116. A reverse rotation direction 118 may also be referenced to describe operation when the spiked object collection system 100 is moved backward. The geometry shown in FIG. 1 defines a cooperative relationship between the direction of propulsion and the axis of rotation of the roller assembly 110.

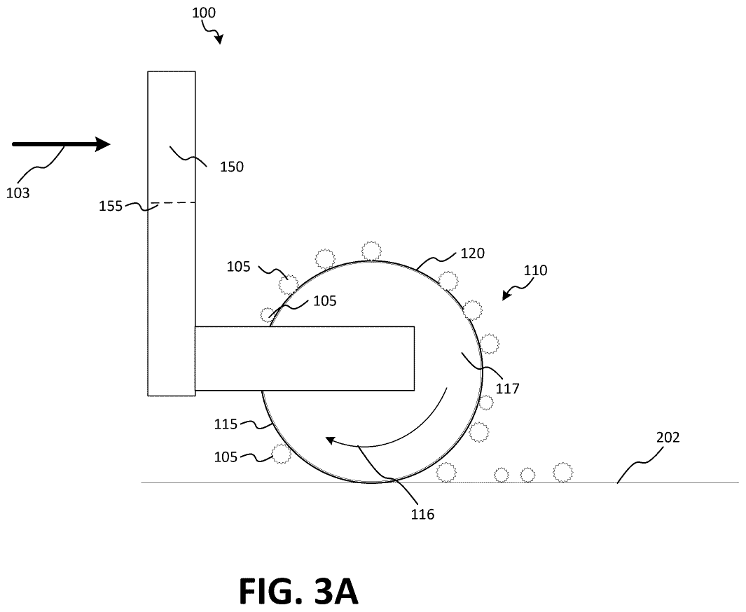

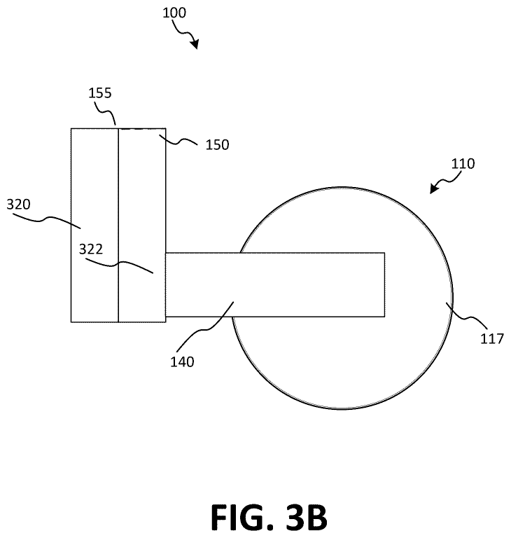

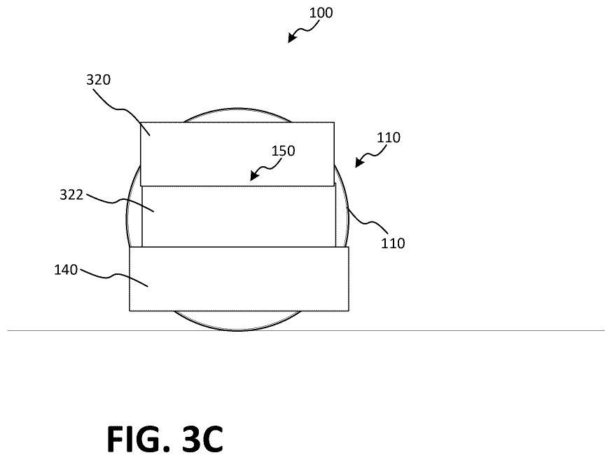

During operation, the outer surface 121 of the roller pad 120 may be configured to engage a surface (e.g., a surface 202 as illustrated in FIG. 3A) and to collect spiked objects therefrom. As the spiked object collection system 100 is propelled in direction 103, frictional engagement between the surface 202 and the roller pad 120 may cause rotation of the roller assembly 110 in direction 116. Spiked objects (e.g., spiked objects 105, 505, and/or 605) may adhere to the outer surface 121 of the roller pad 120 by mechanical entanglement, adhesive attraction, electrostatic charge, etc., such as based on the surface configuration or composition of the roller pad 120.

In embodiments, the roller pad 120 may be configured as a continuous roll including multiple discrete pad segments separated by segment dividers 130. This segmented configuration may enable the outer surface 121 to be refreshed rapidly when contaminated (e.g., excessively contaminated by spiked objects, excessively worn, etc.) by unrolling and tearing away the outermost pad segment and exposing a new clean pad segment. In this manner, the spiked object collection system 100 may enable uninterrupted (or nearly uninterrupted) collection without requiring removal of the roller assembly 110 or disassembly of any structural components to replace the collection surface.

The structural arrangement shown in FIG. 1 provides an overview of the cooperative interaction of the components of the spiked object collection system 100. For example, the frame 150 may be configured to support the roller mounting assembly 140, which may in turn attached to and/or support the roller assembly 110, including the cylindrical drum 117 of the roller assembly 110. In embodiments, the pad retainer 115 and retainer edges 131 and 132 may be configured to maintain the roller pad 120 in aligned, tensioned engagement around the cylindrical drum 117. In some embodiments, a hinge 155 and connector 160 may be included into the frame 150 to allow folding and/or coupling (e.g., to a handle 162 and/or a vehicle connector 164), depending on the propulsion configuration as described in embodiments of the present disclosure.

The frame 150 may be configured to operate as the principal structural component of the spiked object collection system 100. In embodiments, the frame 150 may be configured to provide mechanical support for the roller assembly 110 and to transmit a propulsion force applied to the system 100 in the direction 103 (or in reverse when pulled). In embodiments, the frame 150 may include a rigid structure made from metallic, plastics, PVC, polymeric, composite materials, and/or a combination thereof. For example, in embodiments, the frame 150 may be formed from tubular steel, PVC, plastic, aluminum alloy, reinforced nylon, and/or fiber-reinforced polymer materials configured to provide high stiffness and durability while maintaining a lightweight construction. In embodiments, the geometry of the frame 150 may include parallel or converging members that support the roller mounting assembly 140 in a position configured for consistent ground contact by the roller assembly 110.

In embodiments, the frame 150 may be configured to receive and direct a propulsion force (e.g., a pushing force in direction 103 and/or a pulling force in the reverse direction from direction 103). The propulsion force may be generated manually by a user through a handle 162 or mechanically by a vehicle through a vehicle connector 164, as described in further detail herein. In this manner, the frame 150 may be configured to operation as a transmission for the propulsion force, distributing the load evenly across the roller mounting assembly 140 and maintaining uniform rotational engagement of the roller assembly 110 with the surface being cleaned.

In embodiments, the frame 150 may include a connector 160 configured to couple the frame 150 to a propulsion source (e.g., the handle 162 or the vehicle connector 164 as described herein). In embodiments, the connector 160 may be removably attached to the frame 150 using threaded fasteners, quick-release pins, interlocking mechanical couplings, screws, bolts, etc. In some embodiments, the connector 160 may enable interchangeability between manual and powered modes of operation, which may allow the same spiked object collection system 100 to be configured for different environments and scales of use.

In embodiments, the frame 150 may be configured for easy-to-store foldable operations. In embodiments, the frame 150 may include a hinge 155 disposed between a first section of the frame and a second section of the frame. The hinge 155 may be configured to facilitate folding or collapsing of the frame 150 to reduce the overall length, storage, and shipping footprint of the spiked object collection system 100. In this manner, the foldable configuration of the frame 150 may enable the spiked object collection system 100 to transition between an extended position suitable for operation and a folded position suitable for transport or compact storage, and/or for shipping, as will be described in more detail with respect to FIGS. 3B and 3C. In embodiments, the hinge 155 may include a lockable joint, detent pin, removable bolt, screws, cam-lock arrangement, etc. configured to secure the frame 150 in the extended position during use.

In embodiments, the frame 150 may be configured to support the roller mounting assembly 140, which may be configured to provide the interface for holding the roller assembly 110. In embodiments, the roller mounting assembly 140 may include a pair of bearing housings, trunnions, or brackets configured to support an axle 113 extending through the roller assembly 110. In embodiments, the roller mounting assembly 140 may be formed integrally with the frame 150 or may be removably secured to the frame 150 to enable disassembly, storage, replacement, and/or replacement of roller components.

In embodiments, the frame 150 may be configured to include a telescoping portion configured to adjust the overall length of the handle and/or connecting segment to accommodate users of different heights. In some embodiments, the frame 150 may include vibration-damping elements such as elastomeric bushings or flexible couplers positioned near the hinge 155 or connector 160 to reduce transmission of vibration from the roller assembly 110 to the propulsion source, which may operate to reduce operator fatigue during use.

The roller assembly 110 may be configured to operate as the collection component of the spiked object collection system 100. In embodiments, the roller assembly 110 may be configured to engage a surface (e.g., a surface 202 or another collection surface) to collect spiked objects 105 disposed thereon. In embodiments, the roller assembly 110 may be configured to rotate about an axle 113 (e.g., in direction 116 or 118) to facilitate continuous collection as the spiked object collection system 100 is moved in a direction 103 (and/or in reverse direction).

In embodiments, the roller assembly 110 may include a cylindrical drum 117, a roller pad 120, and a pad retainer 115 configured to maintain the roller pad 120 in position relative to the cylindrical drum 117. The cylindrical drum 117 may be configured to provide a rigid or semi-rigid support surface around which the roller pad 120 may be wound. In embodiments, the cylindrical drum 117 may be fabricated from metallic materials (e.g., aluminum, stainless steel, steel alloys), plastics, PVC, composite materials, fiberglass, carbon fiber, and/or combinations thereof. In some embodiments, the cylindrical drum 117 may be hollow or solid, such as based on the weight and balance requirements, scale of use, and/or application of the spiked object collection system 100. In embodiments, the cylindrical drum 117 may be manufactured via injection molding, blow molding, etc.

In embodiments, the cylindrical drum 117 may be configured to include the pad retainer 115 extending along at least a portion of the outer circumference of the cylindrical drum 117. The pad retainer 115 may be configured to secure an inner edge or starting end of the roller pad 120, which may operate to maintain tension of the roller pad 120 during rotation when in operation. In embodiments, the pad retainer 115 may include an adhesive region, a mechanical clip, a channel, a slotted insert, a hook-and-loop fastening mechanism, etc. configured to removably secure the roller pad 120 from the cylindrical drum 117.

In embodiments, the roller pad 120 may be configured as a flexible, replaceable collection surface disposed concentrically around the cylindrical drum 117. In embodiments, the roller pad 120 may include an outer surface 121 configured for contact with the ground surface (e.g., surface 202) and an inner surface 122 configured to engage the cylindrical drum 117. In embodiments, the outer surface 121 may be formed from materials configured to facilitate adherence of spiked objects 105, such as textured foam, loop fabric, micro-hook textile, elastomeric polymers, rubberized fabric, and/or adhesive-coated materials. In embodiments, the inner surface 122 may include smooth, low-friction, and/or semi-adhesive characteristics configured to maintain secure attachment to the cylindrical drum 117 while allowing controlled detachment when the pad is unrolled.

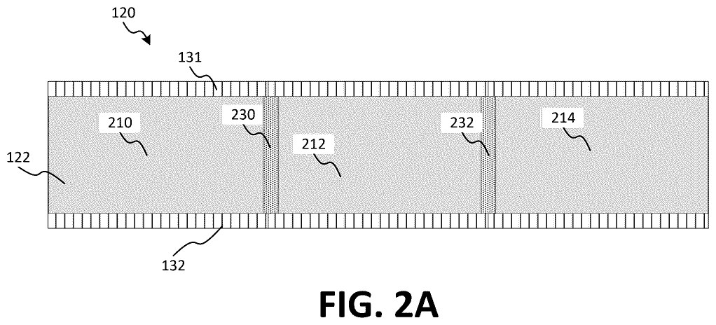

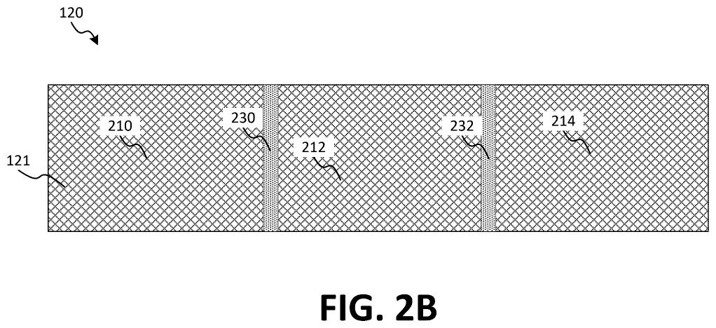

In embodiments, the roller pad 120 may be configured as a rolled member including a plurality of detachable pad segments, each separated by one or more segment dividers 130. In embodiments, each segment divider 130 may be configured to define a predetermined separation point between consecutive pad segments to enable selective removal of a used or contaminated portion of the roller pad 120. Configurations and functionality of the segmented roller pad 120 will be described in more detail with respect to FIGS. 2A and 2B.

In embodiments, the outer surface 121 of the roller pad 120 may be configured to mechanically engage spiked objects (e.g., spiked objects 105), such as grass stickers, prickly thorns, sticker burrs, goat heads, grassburs, sandburs, mesquite thorns, hackberry branches, and other weeds, vegetation, organic or inorganic objects having thorns or spikes, and/or other barbed debris disposed on a surface (e.g., surface 202). In embodiments, the engagement may occur through mechanical entanglement of the barbed surfaces of the spiked objects with the fibers, loops, and/or textured surfaces of the outer surface 121. In additional or alternative embodiments, the engagement between the spiked objects and the outer surface 121 may occur through electrostatic attraction or adhesive tackiness, based on the configuration of the outer surface 121 of the roller pad 120.

In some embodiments, the roller assembly 110 may be removably coupled to the frame 150 to enable replacement, maintenance, and/or cleaning. In embodiments, the removable attachment may be configured using quick-release pins, cotter-secured axles, threaded end caps, and/or other mechanical fasteners configured for rapid removal and reinstallation. The removable functionality of the roller assembly 110 may enable a user to install roller assemblies of different widths, diameters, sizes, shapes, and/or materials to suit different surface conditions, spiked object types, scale of use, etc.

In embodiments, the roller assembly 110 may be configured to operate with consistent contact pressure against the surface being cleaned. The diameter and material compliance of the cylindrical drum 117, in combination with the elasticity of the roller pad 120, may be configured to maintain even distribution of pressure across the contact surface. This configuration may prevent skipping, uneven rotation, loss of contact, etc. that may cause a reduction on of spiked object collection efficiency.

In this manner, the roller assembly 110 may operate as a replaceable and self-renewing collection system of the spiked object collection system 100. The roller assembly 110 may be configured to provide both a mechanical collection function (e.g., through surface engagement) and a structural interface for the segmented roller pad 120. The cooperative operation of the cylindrical drum 117, the roller pad 120, the pad retainer 115, and the roller mounting assembly 140 may collectively provide a self-cleaning and modular, as well as easy-to-maintain, spiked object collection system configured for repeated use and rapid roller pad replacement without the need for disassembly of the spiked object collection system 100.

The roller pad 120 may be configured to operate as the removable and replaceable surface of the spiked object collection system 100. In embodiments, the roller pad 120 may be configured to removably couple to the cylindrical drum 117 and to rotate therewith about the axle 113 during operation of the spiked object collection system 100. In embodiments, the roller pad 120 may be configured to collect spiked objects 105 disposed on a surface (e.g., surface 202) as the roller assembly 110 rotates in a direction (e.g., direction 116 and/or in reverse direction 118).

In embodiments, the roller pad 120 may be configured to provide the main spiked object-collection interface of the spiked object collection system 100. In embodiments, the roller pad 120 may be configured to collect and retain (and subsequently release) spiked objects (e.g., spiked objects 105) through mechanical and/or adhesive engagement, and/or electrostatic attraction based on the configuration of the roller pad 120.

In embodiments, the roller pad 120 may include an outer surface 121 configured for contact with the surface to be cleaned and an inner surface 122 configured to engage the cylindrical drum 117. In embodiments, the outer surface 121 may be configured to capture spiked objects through surface texturing, adhesive coatings, fiber configuration, micro-hook formations, etc., while the inner surface 122 may be configured to adhere or seat against the cylindrical drum 117 and/or to the outer surface 121 to maintain tension and alignment during operation. In embodiments, the roller pad 120 may be configured for controlled removal and replacement, which may enable a contaminated or used pad segment to be removed while leaving a new clean pad segment exposed for continued operation.

In embodiments, the roller pad 120 may be configured as a rolled member including a plurality of detachable pad segments separated by one or more segment dividers 130. In embodiments, each segment divider 130 may be configured to define a separation interface between consecutive pad segments, which may allow the user to remove a used pad segment of the roller pad 120 and expose a clean and fresh pad segment for further use. The segmented configuration of the roller pad 120 may operate to provide continuous operation of the spiked object collection system 100 without requiring disassembly or replacement of the entire roller assembly 110.

In embodiments, the roller pad 120 may include retainer edges 131 and 132 configured to maintain attachment and/or lateral alignment of the roller pad 120 relative to the cylindrical drum 117 during rotation. For example, the retainer edges 131 and 132 disposed on the inner surface 122 of the roller pad 120 may be configured to securely and releasably attach to the outer surface 121 of the roller pad 120 when rolled (e.g., when not unrolled or unwound), which may operate to ensure that the roller pad 120 remains rolled during operation, without becoming unwound inadvertently. In some embodiments, the retainer edges 131 and 132 may be configured to cooperate with the pad retainer 115 disposed on the cylindrical drum 117 to maintain tension and alignment of the roller pad 120 during use. In this manner, the roller pad 120 may be configured to maintain even contact with the ground surface and prevent shifting or detachment during propulsion of the spiked object collection system 100.

It is noted that the configuration and operation of the roller pad 120 may be understood from FIG. 1 as a component configured for removable attachment to the cylindrical drum 117, rotational cooperation with the roller assembly 110, and collection of spiked objects from the surface to be cleaned. Further details related the structure, configuration, features, and functionality of the roller pad 120 (e.g., including specific configurations of the outer surface 121, the inner surface 122, the segment dividers 130, and the retainer edges 131 and 132) are described herein with reference to FIGS. 2A and 2B.

The pad retention system of the spiked object collection system 100 may be configured to secure the roller pad 120 relative to the cylindrical drum 117 during operation. In embodiments, the pad retention system may include the pad retainer 115, the retainer edges 131 and 132, and one or more attachment or alignment interfaces configured to cooperate to maintain the roller pad 120 in a rolled and tensioned condition. In embodiments, the pad retention system may be configured to maintain proper alignment, tension, attachment, and rotational stability of the roller pad 120 while still allowing controlled detachment and replacement of a pad segment as described herein.

In embodiments, the pad retainer 115 may be disposed on or along an outer portion of the cylindrical drum 117. For example, the pad retainer 115 may be configured to secure a starting end, leading edge, or inner edge of the inner surface 122 of the roller pad 120 to the cylindrical drum 117. In embodiments, the pad retainer 115 may include an adhesive surface, a clamping channel, a friction insert, a groove, a slot, a hook-and-loop fastening region, and/or another mechanical interface configured to releasably engage the roller pad 120. In embodiments, the pad retainer 115 may be configured to maintain sufficient engagement to prevent detachment of the roller pad 120 during rotation while allowing removal of the roller pad 120 during replacement operations.

In embodiments, the pad retainer 115 may extend axially across at least a portion of the cylindrical drum 117 to maintain the inner edge of the roller pad 120 in secure engagement. For example, the pad retainer 115 may be configured to cooperate with the retainer edges 131 and 132 disposed along the edges of the inner surface 122 of the roller pad 120 to provide retention during operation. In embodiments, the cooperation between the pad retainer 115 and the retainer edges 131 and 132 may operate to maintain constant tension and alignment of the roller pad 120 while the cylindrical drum 117 rotates about the axle 113.

In embodiments, the retainer edges 131 and 132 may be configured to maintain lateral alignment and secure attachment of the roller pad 120 during use. For example, the retainer edges 131 and 132 may be configured to engage the outer surface 121 of the roller pad 120. In embodiments, the outer surface may include complementary features that may facilitate the engagement with the outer surface 122, such as adhesive bands, hook-and-loop strips, carpet-tack-like pins, magnetic coupling bands, etc. In embodiments, the retainer edges 131 and 132 may be configured to maintain the roller pad 120 in a wound condition when the spiked object collection system 100 is in use, preventing unintentional unrolling or displacement of the roller pad 120. In additional embodiments, the retainer edges 131 and 132 may cooperate with the pad retainer 115 to allow controlled unrolling and rewinding of the roller pad 120 during the pad-replacement process.

In some embodiments, the pad retention system may include alignment or tensioning features configured to maintain uniform contact pressure between the roller pad 120 and the surface being cleaned (e.g., surface 202). For example, the pad retainer 115 and/or the retainer edges 131 and 132 may be configured to maintain consistent radial tension along the cylindrical drum 117 to ensure even rotation and uniform engagement of the outer surface 121 with the surface 202. In this manner, the configuration of the pad retention system may operate to prevent slippage and/or loss of contact that may reduce the collection efficiency or cause uneven wear of the roller pad 120.

In embodiments, the pad retention system shown in FIG. 1 may be configured to operate cooperatively with the segmented structure of the roller pad 120, as described herein with reference to FIGS. 2A and 2B. For example, during removal of a used pad segment, the pad retainer 115 and the retainer edges 131 and 132 may be configured to hold the remaining portion of the roller pad 120 securely to the cylindrical drum 117 while allowing the outermost pad segment to detach along a segment divider 130. In this manner, the pad retention system may be configured to allow selective removal and replacement of pad segments while maintaining continuous attachment of the underlying segments.

It is noted that the configuration and operation of the pad retention system may be understood from FIG. 1 as including the pad retainer 115, the retainer edges 131 and 132, and related structural interfaces configured to secure the roller pad 120 relative to the cylindrical drum 117. Additional embodiments, features, functionality, materials, mechanical and/or configurations of the pad retention system, including further examples of the cooperation between the pad retainer 115, the retainer edges 131 and 132, and the segment dividers 130, are described herein with reference to FIGS. 2A and 2B.

FIGS. 2A and 2B show exemplary embodiments of the roller pad 120 of the spiked object collection system 100 configured with a segmented configuration in accordance with embodiments of the present disclosure. FIGS. 2A and 2B show the roller pad 120 in a generally flat or unrolled configuration for purposes of clarity. FIG. 2A shows a view of the inner surface 122 of the roller pad 120, while FIG. 2B shows a view of the outer surface 121 of the roller pad 120. In embodiments, the inner surface 122 may be configured for attachment to the cylindrical drum 117 and/or the outer surface 121, and the outer surface 121 may be configured for contact with a surface (e.g., surface 202) for collection of spiked objects (e.g., spiked objects 105)

In embodiments, the roller pad 120 may be configured as a flexible, segmented pad structure having a plurality of pad segments 210, 212, 214 separated by one or more segment dividers 230 and 232. In embodiments, the segmentation of the roller pad 120 may be configured to allow the user to remove a used pad segment while leaving the remaining roll secured and tensioned on the cylindrical drum 117. In this manner, the segmented configuration of the roller pad 120 enables rapid refresh of the active collection surface without disassembly of the roller assembly 110.

It is noted that the illustration of three pad segments in FIGS. 2A and 2B is intended for illustrative purposes and should not be construed as limiting in any way. Indeed, in some embodiments, a roller pad may include less or more than three pad segments. For example, in some embodiments, a single pad segment may be used, two pad segments may be used, and/or between three and fifty segment pads may be used. Indeed, limitations on the number of pad segments that may be used may be defined by the application in which the spiked object collection system 100 may be used and/or by size limitations.

FIGS. 2A and 2B also illustrate the retainer edges 131 and 132 disposed along the longitudinal sides of the roller pad 120, which may be configured to cooperate with the pad retainer 115 as described herein to maintain alignment and attachment of the roller pad 120 relative to the cylindrical drum 117 during operation. In embodiments, the cooperation between the pad retainer 115 and the retainer edges 131 and 132 may be configured to be part of the pad retention system of the spiked object collection system 100, as described herein.

In embodiments, the roller pad 120 may include a plurality of pad segments. For example, as shown, the roller pad 120 may include pad segments 210, 212, and 214. In embodiments, each of the pad segments may be separated by a segment divider. For example, as shown, pad segment 210 may be separated from pad segment 212 by segment divider 230, while pad segment 212 may be separated from pad segment 214 by segment divider 232.

In embodiments, the inner surface 122 of the roller pad 120 may be configured to attach to or otherwise engage the cylindrical drum 117 and/or the outer surface 121. For example, while the roller pad is in the rolled state, the roller pad 120 may be wound or rolled into a roll such that the inner surface 122 is positioned to contact the outer surface 121. In embodiments, the inner surface 122 may be configured to provide secure and repeatable attachment to the roller pad 120 roll, while allowing controlled removal and replacement of the roller pad 120 when a pad segment has become saturated or worn.

As shown, the inner surface 122 may be configured to include one or more attachment or retention features configured to promote adhesion, engagement, and/or mechanical coupling with the cylindrical drum 117 and/or the outer surface 121. For example, the inner surface 122 may include an adhesive layer, a hook-and-loop region, a textured or rubberized surface, an array of micro-hooks or suction nodes, or a friction-enhancing coating configured to increase grip against the outer surface 121 and/or the cylindrical drum 117 during rotation.

In embodiments, the inner surface 122 may include a removable or reusable adhesive configured to maintain concentric alignment of the roller pad 120 on the cylindrical drum 117. For example, the adhesive on the inner surface 122 may be configured to securely engage against the outer surface 121. In embodiments, the adhesive or coupling interface may be configured to withstand repeated attachment and detachment cycles without residue or material degradation. In embodiments, the adhesive region may extend continuously along the length of the roller pad 120 or may be disposed intermittently along the inner surface 122 in spaced regions corresponding to the segment boundaries defined by the segment dividers (e.g., segment dividers 230 and 232).

In embodiments, the inner surface 122 may include or define one or more retainer edges 131 and 132 configured to cooperate with complementary structural features of the roller pad 120 and/or the cylindrical drum 117. For example, the retainer edges 131 and 132 may be configured as elongated reinforcement bands, stiffened flanges, magnetic strips, hook-and-loop strips, and/or adhesive seams configured to maintain attachment and/or lateral alignment of the roller pad 120 during rotation of the cylindrical drum 117. In embodiments, the retainer edges 131 and 132 may engage each other, the outer surface 121, and/or the pad retainer 115 disposed on the cylindrical drum 117, forming a cooperative interface configured to maintain the roller pad 120 in a wound and tensioned condition.

In embodiments, the retainer edges 131 and 132 may be configured to facilitate rewinding or re-rolling of the roller pad 120 after a used pad segment has been removed. For example, the retainer edges 131 and 132 may be configured to reattach the newly exposed pad segment 212 to the preceding inner surface 122, enabling the roller pad 120 to remain securely rolled on the cylindrical drum 117 without requiring reinstallation of the entire pad roll.

In embodiments, the inner surface 122 may be manufactured from flexible, resilient, and durable materials configured to maintain integrity during repeated winding and unwinding cycles. Suitable materials for the inner surface 122 may include polyvinyl chloride (PVC), polyethylene (PE), polypropylene (PP), polyurethane (PU), nylon, silicone rubber, thermoplastic elastomers, and/or composites thereof.

In embodiments, the inner surface 122 of the roller pad 120 may be configured to cooperate with the segment dividers 230 and 232 to facilitate separation of pad segments (e.g., pad segments 210, 212, and 214) during replacement. For example, the inner surface 122 may include pre-weakened or scored regions aligned with the segment dividers 230 and 232 to enable clean tearing or peeling along the desired separation lines without disturbing adjacent pad segments.

As shown in FIG. 2B, the outer surface 121 may be configured to operate as the main collection surface of the spiked object collection system 100. In embodiments, the outer surface 121 may be configured to directly contact a surface (e.g., a surface 202) and to capture and retain (and subsequently release) spiked objects (e.g., spiked objects 105) during rotation of the roller assembly 110 in a direction (e.g., direction 116 and/or in reverse direction 118). In embodiments, the outer surface 121 may be configured to include one or more material layers configured for controlled adherence or attachment of spiked objects (e.g., spiked objects 105). For example, the outer surface 121 may include fibers, loops, micro-hooks, protrusions, textured projections, adhesive coatings, electrostatically active surfaces, etc. configured to mechanically engage the spikes or barbs of spiked objects 105. In some embodiments, the outer surface 121 may be configured to include compliant materials that conform to irregularities in the surface 202 to enhance pickup efficiency across uneven terrain.

In embodiments, the outer surface 121 may be formed from one or more materials including polyurethane foam, thermoplastic elastomer (TPE), rubberized fabric, silicone rubber, micro-hook textile, nylon fiber loops, adhesive-backed polymer film, and/or combinations thereof. In embodiments, the selected materials may be configured to ensure sufficient softness and surface texture to engage burrs and thorns, to ensure sufficient resilience to release captured debris during cleaning or pad replacement, and to ensure sufficient durability to withstand repeated ground contact. In embodiments, the outer surface 121 may include alternating or zoned surface regions of differing texture or tackiness, which may operate to optimize collection under mixed surface conditions.

In embodiments, the outer surface 121 may further be configured to include a light adhesive or pressure-sensitive coating configured to enhance capture of spiked objects. In embodiments, the adhesive coating may be formulated for low residue and controlled tackiness, to enable the capture of spiked objects without clogging the outer surface 121. In additional or alternative embodiments, the outer surface 121 may be configured for electrostatic attraction. In these embodiments, the outer surface 121 may include and/or be coated or treated with a static-retentive formulation configured to attract and hold spiked objects (e.g., spiked debris) through charge differentials generated during rotation of the roller assembly 110.

In embodiments, the outer surface 121 may include structural reinforcement configured to prevent tearing or delamination when spiked objects 105 are removed and/or when the roller pad 120 is replaced. For example, the outer surface 121 may include embedded reinforcement fibers, woven fabric scrim layers, bonded overlays, hardened epoxies, etc. configured to resist tensile loads applied during pad removal. In embodiments, the outer surface 121 may be configured to resist puncture and/or wear caused by continuous contact with hard ground surfaces such as asphalt, gravel, compacted soil, debris fields, etc.

In embodiments, the segment dividers 230 and 232 illustrated in FIG. 2B may extend across the outer surface 121 to define pad segments 210, 212, and 214. In embodiments, each segment divider 230 and 232 may be configured to provide a controlled separation line configured for manual tearing or detachment of the outermost pad segment when wound around the cylindrical drum 117. In embodiments, the segment dividers 230 and 232 may include perforations, scored regions, weakened bonding seams, and/or patterned cut lines configured to allow selective removal of one pad segment while leaving the remaining segment segments (e.g., allow removal of pad segment 210 while leaving pad segments 212 and 214) securely attached to the inner surface 122. In embodiments, the segment dividers 230 and 232 may provide alignment between the outer surface 121 and the inner surface 122 so that tearing occurs uniformly across the entire width of the roller pad 120.

In embodiments, the outer surface 121 may cooperate with the retainer edges 131 and 132 to maintain the roller pad 120 in a rolled and tensioned condition. For example, the retainer edges 131 and 132 of the inner surface 122 may be configured to releasably couple to the outer surface 121 when the roller pad 120 is wound on the cylindrical drum 117. This coupling may operate to prevent unintentional unrolling or loosening of the roller pad 120 during rotation of the roller assembly 110. In embodiments, the retainer edges 131 and 132 may include adhesive or frictional contact surfaces configured to maintain even pressure distribution along the width of the roller pad 120 to ensure consistent ground engagement.

In embodiments, the outer surface 121 may be configured to facilitate easy cleaning or decontamination. For example, the roller pad 120 may be rinsed, brushed, or mechanically scraped to remove accumulated spiked objects 105 and surface residue without damaging the collection surface of the outer surface 121. In embodiments, the roller pad 120 may be configured such that the outer surface 121 may be washed or wiped clean and then reused, or alternatively, disposed of and replaced with a new pad roll.

With respect to segment dividers 230 and 232, each segment divider 230 and 232 may be configured to enable the selective removal of a used, worn, damaged, and/or contaminated pad segment (e.g., pad segment 210) from the roller pad 120 while maintaining secure attachment of the remaining pad segments (e.g., pad segments 212 and 214) to the cylindrical drum 117. In this manner, the segment dividers 230 and 232 may be configured to facilitate continuous operation of the spiked object collection system 100 without requiring removal or replacement of the entire roller pad 120.

In embodiments, each segment divider 230 and 232 may extend transversely across the width of the roller pad 120 to define a substantially linear separation region between consecutive or adjacent pad segments. In embodiments, the segment dividers 230 and 232 may be configured to form a series of evenly spaced intervals corresponding to the usable length of each pad segment. In embodiments, the spacing between segment dividers 230 and 232 may be configured to vary based on the intended scale of operation or the surface type to be cleaned.

In embodiments, the segment dividers 230 and 232 may include pre-weakened regions configured to facilitate controlled separation. For example, each segment divider 230 or 232 may include one or more perforations, slits, scored lines, notched channels, weakened adhesive seams, frangible stitching lines, and/or thermally thinned zones configured to allow the user to tear, peel, or otherwise separate the outermost pad segment 210 from the roller pad 120. The controlled weakening of each segment divider 230 and 232 may be configured to allow separation to occur without disturbing the structural integrity of the remaining pad segments 212 and 214.

In embodiments, the segment dividers 230 and 232 may be configured as peelable or separable adhesive interfaces. For example, each segment divider 230 or 232 may include a pressure-sensitive adhesive bond, a releasable polymer film, a tacky contact layer, etc. configured to hold consecutive pad segments together during operation while allowing the user to manually peel the used pad segment away from the underlying pad segment. In embodiments, the adhesive strength of the segment dividers 230 and 232 may be configured to exceed the operational shear stresses generated during rotation of the roller assembly 110 while remaining low enough to allow clean separation when manually peeled by the user.

In embodiments, the segment dividers 230 and 232 may be configured as stitched or mechanically joined seams. For example, the segment dividers 230 and 232 may include a chain-stitch, lock-stitch, and/or pull-thread seams configured to unravel or disengage when a force is applied along the divider. In embodiments, the stitched or mechanically coupled segment dividers 230 and 232 may be configured to maintain pad integrity under compression and torsion during use, but may release upon activation of the stitched or mechanical release structure.

In some embodiments, the segment dividers 230 and 232 may be configured as non-joined modular interfaces, wherein adjacent pad segments (e.g., e.g., pad segments 210, 212, and 214) are not physically bonded or stitched to one another but are instead held in place by frictional, interlocking, and/or self-retaining engagement between the inner surface 122 of the roller pad 120 and the cylindrical drum 117. For example, in embodiments, each pad segment may be configured as an independent sheet or strip configured to overlap partially with an adjacent segment along an overlap zone. The overlap zone may be configured to maintain continuous coverage of the outer surface 121 while allowing the outermost pad segment to be unrolled and removed independently of the remaining pad segments. In this manner, the modular, non-joined configuration of the segment dividers 230 and 232 may be configured to allow sequential replacement of individual pad segments without tearing, peeling, or breaking a physical seam, which may simplify replacement of the collection surface of the roller pad 120 during repeated use.

In some embodiments, the segment dividers 230 and 232 may include visual and/or tactile indicators configured to assist a user in identifying where the separation should occur. For example, the segment dividers 230 and 232 may include color bands, printed markings, embossed ridges, textured strips, and/or recessed grooves configured to provide visible and/or tactile feedback. The indicators may allow a user to easily locate the correct separation region in both well-lit and low-light conditions, which may facilitate accurate pad-segment replacement in the field.

In embodiments, the segment dividers 230 and 232 may be configured to maintain continuous structural and material alignment between the outer surface 121 and the inner surface 122 of the roller pad 120. For example, the segment dividers 230 and 232 may be configured to extend through both layers of the roller pad 120 so that separation occurs along a single transverse line. In embodiments, this alignment between the outer surface 121 and the inner surface 122 may be configured to prevent uneven tearing or misalignment between pad segments. In embodiments that implement perforated dividers, a user may grasp an exposed edge of the outermost pad segment 210 and pull tangentially relative to the cylindrical drum 117 to propagate a controlled tear along the segment divider 230. In additional or alternative embodiments that implement peelable adhesive seams, a user may separate the adhesive bond by peeling the used pad segment 210 away from the underlying pad segment 212 to complete removal. In embodiments that implement a stitched divider, a pull-thread or chain-stitch may be configured to unravel when tension is applied, releasing the used pad segment 210 for removal. In embodiments that implement non-joined segment interfaces, the segments may be held in place by the self-retaining features on the inner surface 122 so that the used pad segment 210 may be unrolled and removed without tearing.

In embodiments, the segment dividers 230 and 232 may cooperate with the pad retention system (e.g., the pad retainer 115 and/or the retainer edges 131 and 132) to maintain secure attachment of the remaining roller pad roll to the cylindrical drum 117 while one pad segment is removed. For example, during removal of the outermost pad segment 210, the pad retainer 115 and the retainer edges 131 and 132 may be configured to hold the inner surface 122 of the remaining pad segments 212 and 214 in place, preventing unintentional detachment or slackening of the roller pad 120. This functionality may ensure that once a pad segment (e.g., pad segment 210) is removed, the next segment (e.g., pad segment 212) assumes the operative position as the new outer surface 121 of the roller pad 120.

In embodiments, the configuration of the segment dividers 230 and 232 may be optimized for various environmental and operational conditions. For example, in dry, sandy, or debris-heavy environments, the segment dividers 230 and 232 may be configured with wider or deeper perforations to facilitate easier separation. In wet or high-humidity environments, the segment dividers 230 and 232 may be configured with reinforced seams or polymer-coated perforations configured to prevent unintended tearing due to moisture-induced weakening.

In embodiments, the segment dividers 230 and 232 may be manufactured concurrently with the roller pad 120 as part of a continuous extrusion or lamination process. In other embodiments, the segment dividers 230 and 232 may be formed post-fabrication by mechanical scoring, die-cutting, laser etching, and/or ultrasonic embossing.

FIG. 3A shows an exemplary spiked object collection system 100 during operation for collecting spiked objects from ground surfaces in accordance with embodiments of the present disclosure. As shown in FIG. 3A, a force propels the spiked object collection system 100 in direction 103, causing the roller assembly 110 to rotate about the axle 113. The roller pad 120, secured to the cylindrical drum 117 by the pad retainer 115 and retainer edges 131 and 132, may be configured to contact the surface 202 and may engage the spiked objects 105 disposed thereon. In embodiments, the spiked object collection system 100 may be configured for manual or mechanical propulsion through the frame 150, the connector 160, and a handle 162 or vehicle connector 164.

In embodiments, as the roller assembly 110 rotates in direction 116, the outer surface 121 of the roller pad 120 may be configured to contact and capture spiked objects 105 through mechanical, adhesive, and/or electrostatic engagement. In embodiments, the geometry, texture, configuration, and/or compliance of the roller pad 120 may be configured to conform to small surface irregularities, allowing the spiked objects 105 to become embedded within or adhered to the outer surface 121. In embodiments, the captured spiked objects 105 may remain retained on the roller pad 120 until the corresponding pad segment 210 becomes saturated, at which point the pad segment 210 may be removed from the roller pad 120 in accordance with embodiments of the present disclosure.

In embodiments, the frame 150 and roller mounting assembly 140 may be configured to maintain the roller assembly 110 in consistent contact with the surface 202 to ensure continuous engagement between the roller pad 120 and the spiked objects 105. The distributed weight of the frame 150 may be configured to provide even contact pressure across the roller width while preventing excessive compression that might prevent rotation. In embodiments, the material and geometric configuration of the roller pad 120 may be configured to prevent accumulation of soil, dust, debris, and/or moisture that may reduce the collection efficiency of the spiked object collection system 100.

In embodiments, as the spiked object collection system 100 advances, a collected region of spiked objects 105 may form on the outer surface 1212 of the roller pad 120. The collection process may continue as the roller assembly 110 rotates, continually exposing the outer surface 121 of the roller pad 120 to the surface 202. When a pad segment (e.g., the outer surface 121 of a pad segment) becomes saturated, the user may stop operation and remove that pad segment along a segment divider 230, which may expose a clean pad segment for continued use. This removal of the saturated pad segment may be performed without disassembly of the spiked object collection system 100.

FIGS. 3B and 3C illustrate operations of a spiked object collection system 100 configured with foldable configurations in accordance with embodiments of the present disclosure. For example, in embodiments, spiked object collection system 100 may be configured with an extended configuration and a folded configurations. FIG. 3A may show the spiked object collection system 100 in the extended configuration for spiked objects collection operations, while FIGS. 3B and 3C illustrate operations to fold the spiked object collection system 100 into a folded configuration (as shown in FIG. 3C) for transport, storage, and/or shipping.

As shown in FIG. 3B, the spiked object collection system 100 may be in a partially folded configuration. FIG. 3C shows the system 100 in a fully folded configuration for storage, shipping, and/or transport. In embodiments, the frame 150 may include a first frame section 320 and a second frame section 322 joined by a hinge 155. In embodiments, the hinge 155 may be configured to allow rotational movement of the first frame section 320 relative to the second frame section 322 about a transverse hinge axis. In embodiments, the hinge 155 may include a lockable pivot, detent pin, removable bolt, or cam-lock coupling configured to secure the frame 150 in either an extended or folded position.

In embodiments, the hinge 155 may be disposed proximate to a midpoint of the frame 150 such that the first frame section 320 may support the roller mounting assembly 140 and the second frame section 322 may support the connector 160 and the handle 162 (or the vehicle connector 164). In this manner, the spiked object collection system 100 may be configured to fold generally in half, reducing the overall length by approximately fifty percent for transport, shipping, and/or storage. In some embodiments, the overall length of the spiked object collection system 100 may be reduced by anywhere between 20-70%.

In embodiments, when the spiked object collection system 100 is in the extended position (as shown in FIG. 3A), the hinge 155 may be configured to remain locked. The hinge 155 may include a spring-loaded pin, a ratcheting mechanism, or a quick-release latch configured to maintain alignment of the frame 150 during propulsion in direction 103. The locked position of the hinge 155 may prevent relative motion between the first frame section 320 and the second frame section 322 that may otherwise affect ground contact of the roller assembly 110.

In embodiments, the folded configuration shown in FIG. 3C may be configured for compact storage within a confined space such as a vehicle, storage cabinet, shed, etc. and/or for easy shipping. In the folded configuration, the roller assembly 110 may remain attached to the roller mounting assembly 140 while the second frame section 322 pivots downward about a pivot point between the roller mounting assembly 140 and the second frame section 322. This functionality may be configured to position the handle 162 and/or connector 160 adjacent to or above the roller assembly 110, minimizing the footprint of the spiked object collection system 100.

In embodiments, the hinge 155 may further be configured to include a locking detent or positive-stop mechanism that defines both the operational and folded limits of rotation. For example, the hinge 155 may include a pin-and-slot assembly configured to facilitate rotation through an angle of approximately 180 degrees between the extended and folded positions. In embodiments, the connector 160 may be configured to remain coupled to the first frame section 320 during folding. For example, the connector 160 may be positioned such that the coupling interface (for attachment to the handle 162 or the vehicle connector 164) remains outwardly accessible when folded. This configuration may allow the spiked object collection system 100 to be stored in a ready-to-deploy condition without requiring disconnection of the propulsion components.

In embodiments, the handle 162 may include a telescoping portion configured to retract during folding. For example, the handle 162 may be configured to collapse inwardly into the first frame section 320, further reducing the overall folded length of the spiked object collection system 100. The telescoping mechanism may include a spring-biased button, a twist-lock, or a detent pin configured to hold the handle 162 at various extension lengths during use or storage.

In embodiments, the hinge 155 may be configured to enable partial folding for intermediate transport. For example, the user 550 may unlock the hinge 155, fold the frame 150 to an intermediate angle, and lift the spiked object collection system 100 by the handle 162, allowing the roller assembly 110 to roll on the ground during transport. This partially folded configuration may be configured for moving the spiked object collection system 100 between collection areas without completely disassembling or carrying it.

In some embodiments, the spiked object collection system 100 may include one or more auxiliary wheels or rollers (not shown) attached to the frame 150 to facilitate transport when folded. The auxiliary rollers may be configured to engage the ground when the frame 150 is tilted to a transport orientation, allowing the user 550 to roll the folded unit. In embodiments, the folding configuration shown in FIGS. 3B and 3C may be configured to enable modular packaging and shipment of the spiked object collection system 100. For example, the folded system may be configured to fit within a shipping box or case, with roller assembly 110 nested compactly to minimize shipping volume, or without the roller assembly 110 in some embodiments.

In some embodiments, the foldable configuration of the frame 150 may also allow multiple spiked object collection systems 100 to be stacked or stored together. The folded configuration may be configured to prevent interference between adjacent roller assemblies 110, enabling efficient storage or shipment of several units in a limited area.

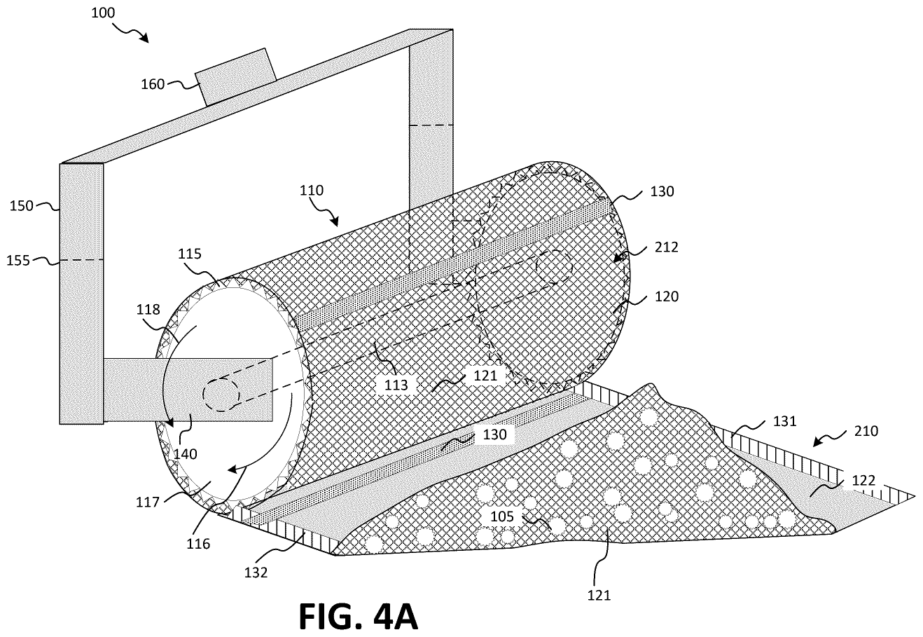

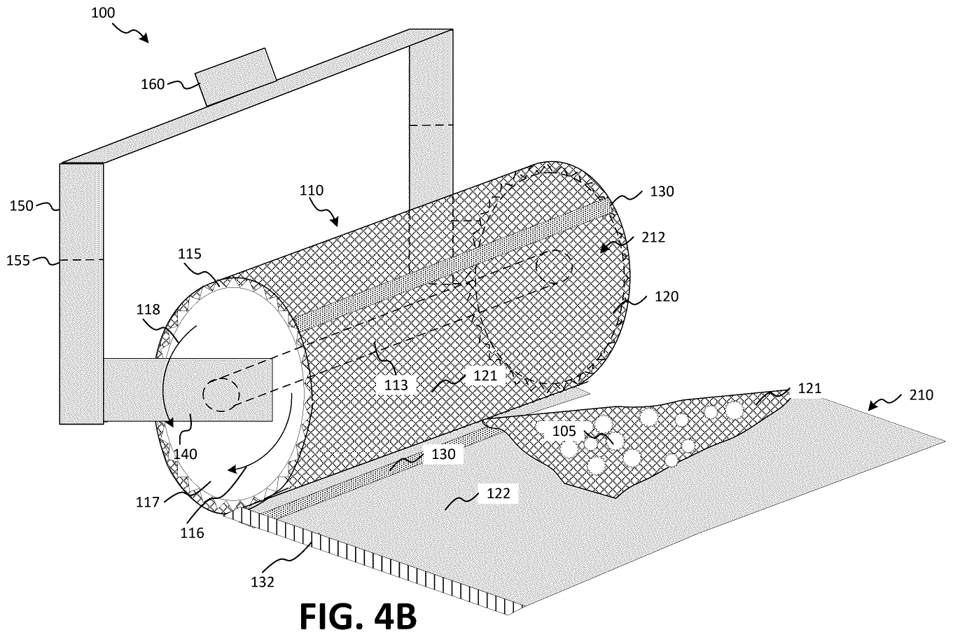

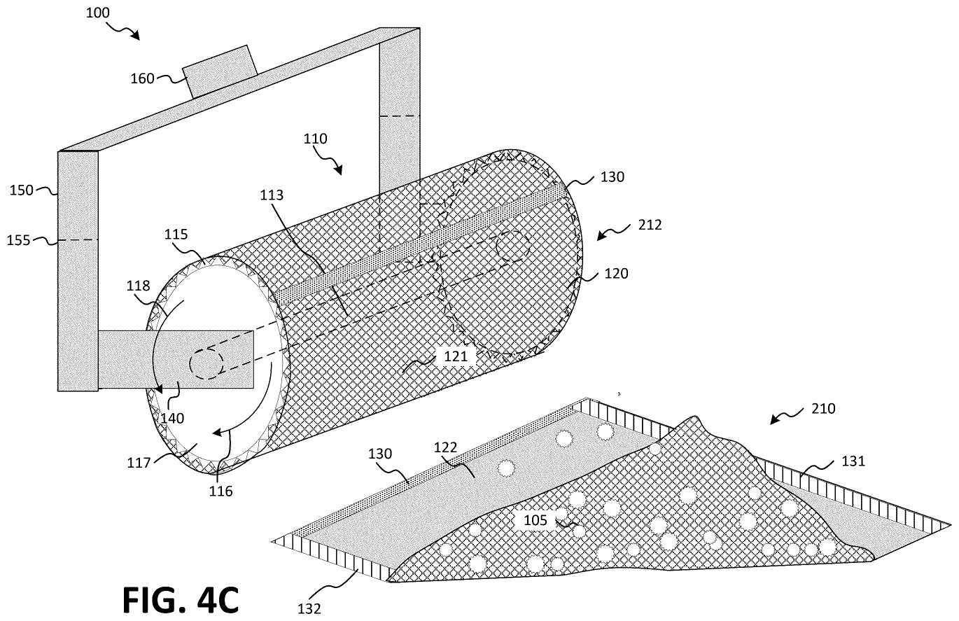

FIGS. 4A-4C illustrate operations for refreshing roller pad 120 by removal of a saturated pad segment in accordance with embodiments of the present disclosure. In embodiments, the roller assembly 110 may remain attached to the frame 150 during pad segment replacement. In some embodiments, the spiked object collection systems 100 may be configured to enable pad replacement without requiring any tools or disassembly, allowing the user 550 to perform maintenance in the field.

In embodiments, as shown in FIG. 4A, during operation, the roller pad 120 may be rolled over a surface to collect spiked objects, with pad segment 210 currently the operative collection surface. As shown, the outer surface 121 of the pad segment 210 may be covered with spiked objects 105. The next pad segment 212 (e.g., in the roller pad 120) may be covered by the pad segment 210 such that the pad segment 212 is not exposed, and such that the pad segment 210 is rolled over the next pad segment 212. In embodiments, the pad segment 210 may be securely attached to the next pad segment using the retainer edges 131 and 132 on the inner surface 122 of the pad segment 210 (or on the outer surface 121). In embodiments, the user 550 may peel or detach the pad segment 210 from the next pad segment 212, operatively detaching or unrolling the pad segment 210 from the next pad segment 212, as shown in FIG. 4A, and exposing a clean outer surface 121 of the next pad segment 212.

In embodiments, the used pad segment 210 may be attached to the next pad segment 212 along a segment divider 230 with functionality as described herein. In embodiments, as shown in FIG. 4B, the user 550 may grasp an exposed edge or tab of the used pad segment 210 and apply a tangential pulling motion in direction 118 or an upward peeling motion, to separate the used pad segment 210 from the next pad segment 212, operatively detaching or tearing the used pad segment 210 from the next pad segment 212.

In embodiments, the pad retention system (including the pad retainer 115 and retainer edges 131 and 132) may remain engaged with the cylindrical drum 117 during removal. This functionality may be configured to maintain the remaining roller pad 120 under tension so that removal of the used pad segment 210 does not loosen the inner surface 122 of the remaining pad segments 212 and 214. In embodiments, the cooperative tensioning provided by the pad retention system may ensure that only the targeted pad segment 210 detaches along the segment divider 230 while the remainder of the roller pad 120 remains securely rolled.

FIG. 4C illustrates the spiked object collection system 100 after the used pad segment 210 has been completely removed. The clean next pad segment 212 may now function as the new active surface for collection. The outer surface 121 of the new pad segment 212 may be clean, uncontaminated, and ready for operation. The user 550 may simply re-engage the roller pad 120 with the surface 202 to resume collection without any additional assembly steps.

In embodiments, when the used pad segment 210 has been fully detached, the pad segment 210 may be manually rolled, folded, or otherwise compacted for disposal. The used pad segment 210 may contain the accumulated spiked objects 105, which may remain attached to the outer surface 121. In this manner, the removal of the used pad segment 210 may remove the collected debris in a single motion, simplifying cleanup and eliminating direct user contact with the spiked objects 105. In embodiments, the materials used to form the roller pad 120 and the segment dividers 230 and 232 may be configured to allow eco-friendly disposal or recycling. For example, the used pad segment 210 may be made from biodegradable, compostable, or recyclable materials configured to minimize environmental impact.

In some embodiments, the pad retainer 115 may be configured to include a releasable engagement portion that may be momentarily lifted or loosened during replacement to relieve tension and allow clean removal of the used pad segment 210. Once the new pad segment 212 is exposed, the pad retainer 115 may be re-secured to restore operating tension. In this manner, the pad retainer 115 may operate as a retention and re-tensioning component for maintaining operational stability of the roller pad 120.

In embodiments, the pad replacement sequence shown in FIGS. 4A-4C may be performed repeatedly until all pad segments of the roller pad 120 have been used. At such point, the entire roller pad 120 may be removed from the cylindrical drum 117 and replaced with a new roller pad.

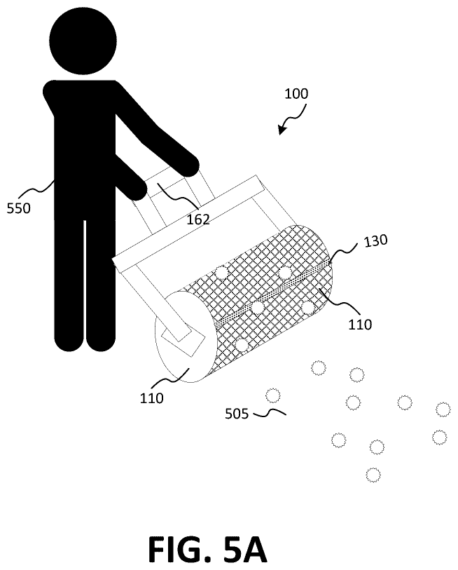

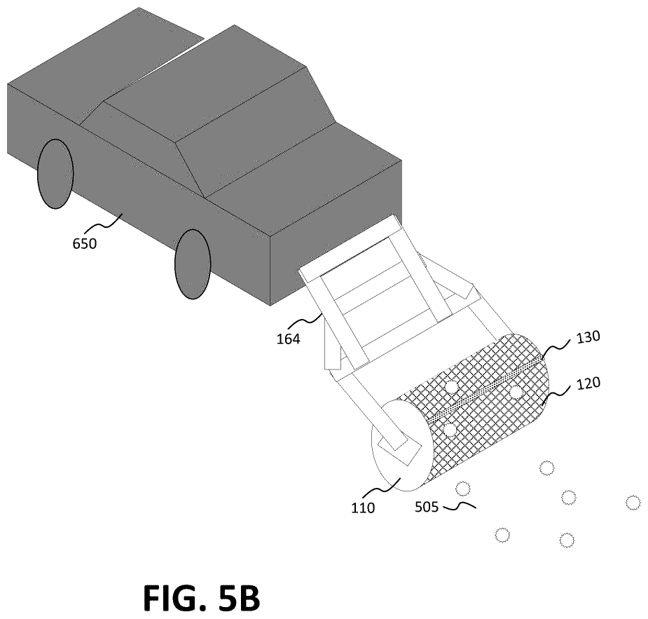

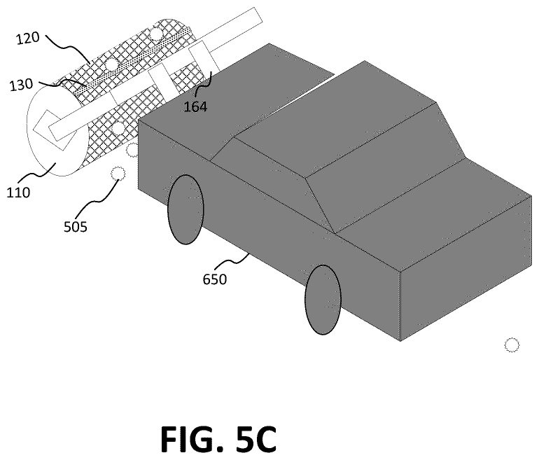

FIGS. 5A-5C exemplary operations of a spiked object collection device 100 propelled bunder various propulsion configurations in accordance with embodiments of the present disclosure. In particular, FIG. 5A illustrates a manually propelled configuration operated by a user 550, and FIGS. 5B and 5C illustrate vehicle-propelled configurations in which the spiked object collection system 100 is coupled to a vehicle 650.

In embodiments, and as shown in FIG. 5A, the user 550 may manually push or pull the spiked object collection system 100 across a surface 202. In embodiments, the handle 162 may be configured to transmit a propulsion force through the connector 160 to the frame 150, causing rotation of the roller assembly 110 about the axle 113. As the roller pad 120 rotates, the outer surface 121 of the roller pad 120 may contact the ground and collect spiked objects 505 through mechanical, adhesive, and/or electrostatic engagement.

In embodiments, and as shown in FIGS. 5B and 5C, the spiked object collection system 100 may be configured for vehicle propulsion through a vehicle connector 164 attached to the frame 150. In embodiments, the vehicle connector 164 may be configured as a hitch or tow bar that couples to the front portion of the vehicle 650 (e.g., a truck, tractor, trailer, forklift, lawnmower, autonomous vehicle, autonomous lawnmower, etc.) as shown in FIG. 5B, or the rear portion of the vehicle 650 as shown in FIG. 5C. During movement of the vehicle 650, a pushing force (e.g., as shown in FIG. 5B) or a pulling force (e.g., as shown in FIG. 5C) may be transmitted through the vehicle connector 164 to the frame 150, causing the roller assembly 110 to rotate and collect spiked objects 505 from the surface 202. This powered configuration may be configured for medium to large-area operation, such as pastures, fields, parking lots, etc.

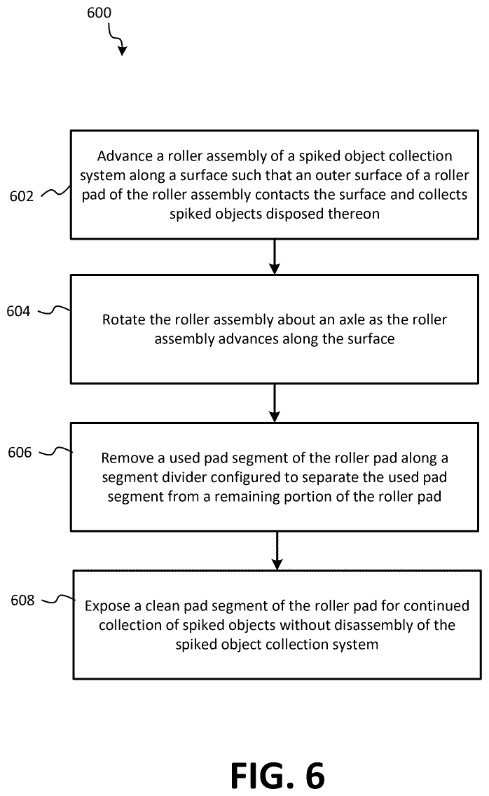

FIG. 6 shows a high-level flow diagram 600 of operation for collecting spiked objects from a surface in accordance with embodiments of the present disclosure. For example, the functions illustrated in the example blocks shown in FIG. 6 may be performed using spiked object collection system 100 of FIG. 1 according to embodiments herein.

At block 602, a roller assembly of a spiked object collection system is advanced along a surface such that an outer surface of a roller pad of the roller assembly contacts the surface and collects spiked objects disposed thereon. In embodiments, the spiked object collection system may include a spiked object collection system (e.g., spiked object collection system 100 of FIG. 1). In embodiments, the spiked object collection system may include functionality and may perform operations according to operations and functionality as described above with reference to spiked object collection system 100, and as illustrated in FIGS. 1-5C.

At block 604, the roller assembly is rotated about an axle as the roller assembly advances along the surface. For example, a propulsion force may be applied against the spiked object collection system causing the roller assembly to rotate about the axle as it advances over the surface. In embodiments, operations of the roller assembly may include functionality and operations according to operations and functionality as described above with reference to roller assembly 110, and as illustrated in FIGS. 1-5C.

At block 606, a used pad segment of the roller pad is removed along a segment divider configured to separate the used pad segment from a remaining portion of the roller pad. For example, in embodiments, functionality for removing a pad segment may include functionality and operations according to operations and functionality as described above with reference to removal of pad segment 210, and as illustrated in FIGS. 1-5C.

At block 608, a clean pad segment of the roller pad is exposed for continued collection of spiked objects without disassembly of the spiked object collection system. For example, in embodiments, functionality for exposing a clean pad segment may include functionality and operations according to operations and functionality as described above with reference to exposure of next pad segment 212, and as illustrated in FIGS. 1-5C.

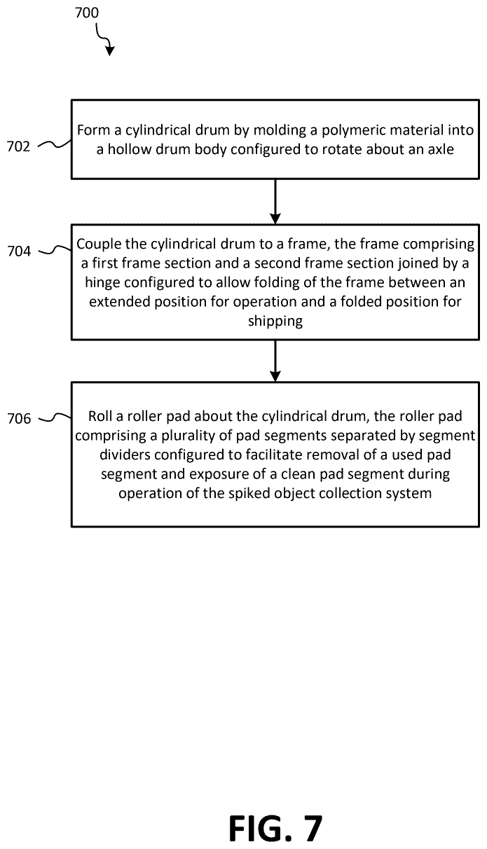

FIG. 7 shows an exemplary flow diagram 700 of operations for manufacturing a device configured with functionality to collect spiked objects from a surface in accordance with embodiments of the present disclosure. For example, the steps illustrated in the example blocks shown in FIG. 7 may be performed to manufacture spiked object collection system 100 of FIG. 1 according to embodiments herein.

At block 702, a cylindrical drum (e.g., cylindrical drum 117 of FIG. 1) may be formed by molding a polymeric material into a hollow drum body configured to rotate about an axle, such as illustrated in FIGS. 1-5C. At block 704, the cylindrical drum is coupled to a frame (e.g., frame 150 of FIGS. 1-5C). In embodiments, the frame may include a first frame section (e.g., first section 320 of FIGS. 3B and 3C) and a second frame section (e.g., second section 322 of FIGS. 3B and 3C) joined by a hinge (e.g., hinge 155 of FIGS. 3A-3C) configured to allow folding of the frame between an extended position for operation and a folded position for shipping, as illustrated in FIGS. 3A-3C.

At block 706, a roller pad (e.g., roller pad 120 of FIGS. 1-5C) is rolled about the cylindrical drum. In embodiments, the roller pad may include a plurality of pad segments (e.g., pad segments 210, 212, and 214 of FIGS. 2A, 2B, and 4A-4C) separated by segment dividers (e.g., segment dividers 130, 230, and 232 of FIGS. 1-5C) configured to facilitate removal of a used pad segment (e.g., used pad segment 210 as illustrated in FIG. 4A-4C) and exposure of a clean pad segment (e.g., next pad segment 212 as illustrated in FIG. 4A-4C) during operation of the spiked object collection system.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A method of collecting spiked objects from a surface using a spiked object collection system, the method comprising:
advancing a roller assembly of a spiked object collection system along a surface such that an outer surface of a roller pad of the roller assembly contacts the surface and collects spiked objects disposed thereon;
rotating the roller assembly about an axle as the roller assembly advances along the surface;
removing a used pad segment of the roller pad along a segment divider configured to separate the used pad segment from a remaining portion of the roller pad; and
exposing a clean pad segment of the roller pad for continued collection of spiked objects without disassembly of the spiked object collection system.

2. The method of claim 1, wherein the segment divider includes one or more of perforations, adhesive seams, scored lines, frangible stitching, and modular overlapping interfaces configured to enable manual separation of the used pad segment.

3. The method of claim 1, further comprising:
maintaining the roller pad under tension during pad-segment removal using a pad retainer and lateral retainer edges configured to secure the roller pad to a cylindrical drum of the roller assembly.

4. The method of claim 1, further comprising:
continuing operation of the spiked object collection system after the used pad segment is removed, wherein the exposed clean pad segment becomes an operative collection surface.

5. The method of claim 1, further comprising:
folding the frame of the spiked object collection system about a hinge disposed between a first frame section and a second frame section to reduce a shipping footprint of the spiked object collection system.

6. The method of claim 5, further comprising:
securing the hinge in the folded position using a latch, detent pin, or locking joint configured to retain the spiked object collection system in a compact configuration during transport or storage.

7. The method of claim 1, wherein the cylindrical drum of the roller assembly is formed by injection molding or blow molding, the method further comprising:
manufacturing the cylindrical drum as a hollow lightweight component.

8. The method of claim 1, further comprising:
repeating the removing and exposing steps for each of a plurality of pad segments until the roller pad is exhausted; and
replacing the roller pad with a new roller pad thereafter.

9. The method of claim 1, wherein advancing the spiked object collection system includes manually pushing or pulling the system using one or more of:
a handle; and
towing the system with a vehicle via a vehicle connector coupled to the frame.

10. A spiked object collection system comprising:
a frame configured to support a roller assembly;
a hinge disposed between a first frame section and a second frame section, the hinge configured to facilitate folding of the frame between an extended position for operation and a folded position for storage;
a cylindrical drum rotatably mounted to the frame and configured to rotate about an axle; and
a roller pad wound about the cylindrical drum, the roller pad comprising a plurality of pad segments separated by segment dividers configured to enable removal of a used pad segment and exposure of a clean pad segment without disassembly of the spiked object collection system.

11. The system of claim 10, further comprising a pad retention system including:
a pad retainer disposed on the cylindrical drum; and
a pair of retainer edges disposed along opposite longitudinal sides of the roller pad, the pad retention system configured to maintain alignment and tension of the roller pad during operation.

12. The system of claim 10, wherein each segment divider includes one or more of a perforated, scored, adhesive, stitched, or modular overlapping interface configured to allow manual separation of the used pad segment.

13. The system of claim 10, wherein the roller pad includes:
an outer surface configured for contact with the surface; and
an inner surface configured for engagement with the cylindrical drum, the outer surface comprising a textured, adhesive, or electrostatically active material configured to capture spiked objects.

14. The system of claim 10, wherein the hinge includes a lockable pivot, cam latch, or detent mechanism configured to secure the frame in the extended position during operation and in the folded position during storage.

15. The system of claim 10, wherein the cylindrical drum is formed by injection molding or blow molding and includes a hollow interior, a uniform wall thickness, and integrated mounting features configured to receive the axle.

16. The system of claim 10, wherein the frame further comprises:
a connector configured to selectively couple to a handle for manual propulsion or to a vehicle connector for mechanical towing.

17. The system of claim 10, wherein the roller pad is removably attachable to the cylindrical drum and configured for replacement with a new roller pad upon exhaustion of all pad segments.

18. The system of claim 10, wherein the folded position of the frame positions the handle and the cylindrical drum in proximity to each other to reduce overall length and facilitate compact storage or shipment.

19. The system of claim 10, wherein the frame and hinge are formed from metallic, polymeric, or composite materials.

20. A method of manufacturing a spiked object collection system configured for collection of spiked objects from a surface, the method comprising:
forming a cylindrical drum by molding a polymeric material into a hollow drum body configured to rotate about an axle;
coupling the cylindrical drum to a frame, the frame comprising a first frame section and a second frame section joined by a hinge configured to allow folding of the frame between an extended position for operation and a folded position for shipping; and
rolling a roller pad about the cylindrical drum, the roller pad comprising a plurality of pad segments separated by segment dividers configured to facilitate removal of a used pad segment and exposure of a clean pad segment during operation of the spiked object collection system.
